(19) United States
(12) Patent Application Publication
(10) Pub. No.: US 2019/0152460 A1
(43) Pub. Date: May 23, 2019

(54) ELECTROMECHANICAL BRAKE SYSTEM INCLUDING A PARKING LOCK

(71) Applicant: GM Global Technology Operations LLC, Detroit, MI (US)

(72) Inventors: David B. Antanaitis, Northville, MI (US); Mark T. Riefe, Brighton, MI (US); Kevin D. Connor, Armada, MI (US)

(21) Appl. No.: 15/820,750

(22) Filed: Nov. 22, 2017

(51) Int. Cl. B60T 13/74; B60T 17/18

(52) U.S. Cl. CPC B60T 13/741; F16D 2127/06; B60T 17/18

(57) ABSTRACT

An electromechanical brake system includes a caliper, an electric motor mounted to the caliper, a gear element mechanically connected to the electric motor, an actuator supported by the caliper, the actuator including an actuation member, and a controller operatively connected to the actuator. The controller is operable to selectively engage the actuation member with the gear element to positionally lock the first caliper member relative to the second caliper member.

### INTRODUCTION

The subject disclosure relates to the art of braking systems and, more particularly, to an electromechanical brake including a parking lock.

Electromechanical brake systems rely on an electric signal to operate a brake actuator or caliper. The electric signal activates a motor which drives a gear system coupled to the caliper. The motor shifts the caliper so as to bring together brake pads with a rotor. The motor does not include a locking feature. Accordingly, a separate mechanical system is employed to provide a parking brake. Typically, the separate mechanical system includes a cable or hydraulic conduit that delivers a clamping force to the caliper. The use of cables and/or hydraulics increases an overall cost and complexity of the braking system. Accordingly, it is desirable to provide a braking system in which a parking brake may be integrated into an electromechanical brake system.

### SUMMARY

In accordance with an aspect of an exemplary embodiment an electromechanical brake system includes a caliper including a first caliper member and a second caliper member, an electric motor mounted to the caliper, a gear element mechanically connected to the electric motor, an actuator supported by the caliper, the actuator including an actuation member, and a controller operatively connected to the actuator. The controller is operable to selectively engage the actuation member with the gear element to positionally lock the first caliper member relative to the second caliper member.

In addition to one or more of the features described herein include wherein the actuator comprises a solenoid and the actuation member comprises a solenoid plunger.

In addition to one or more of the features described herein include wherein the gear element includes a parking gear including a plurality of tooth elements, each of the plurality of tooth elements including at least one surface that extends at a non-zero angle relative to a radius of the gear element.

In addition to one or more of the features described herein include wherein the actuation member includes a terminal end portion including an angled surface.

In addition to one or more of the features described herein include a biasing element operatively connected to the actuation member, the biasing element biasing the actuation member in one of a deployed configuration and a non-deployed configuration.

In addition to one or more of the features described herein include wherein the biasing element biases the actuation member in each of the deployed configuration and the non-deployed configuration.

In addition to one or more of the features described herein include wherein the biasing element comprises an over-center spring.

In accordance with another aspect of an exemplary embodiment, a vehicle includes a body, a prime mover connected to the body, a plurality of wheels connected to the prime mover, and an electromechanical brake system operatively connected to at least one of the plurality of wheels. The electromechanical brake system includes a caliper including a first caliper member and a second caliper member, an electric motor mounted to the caliper, a gear element mechanically connected to the electric motor, an actuator supported by the caliper, the actuator including an actuation member, and a controller operatively connected to the actuator. The controller is operable to selectively engage the actuation member with the gear element to positionally lock the first caliper member relative to the second caliper member.

In addition to one or more of the features described herein include the actuator comprises a solenoid and the actuation member comprises a solenoid plunger.

In addition to one or more of the features described herein include wherein the gear element includes a parking gear including a plurality of tooth elements, each of the plurality of tooth elements including at least one surface that extends at non-zero angle relative to a radius of the gear element.

In addition to one or more of the features described herein include wherein the actuation member includes a terminal end portion including an angled surface.

In addition to one or more of the features described herein include a biasing element operatively connected to the actuation member, the biasing element biasing the actuation member in one of a deployed configuration and a non-deployed configuration.

In addition to one or more of the features described herein include wherein the biasing element biases the actuation member in each of the deployed configuration and the non-deployed configuration.

In addition to one or more of the features described herein include wherein the biasing element comprises an over-center spring.

In accordance with another aspect of an exemplary embodiment, a method of applying a parking brake for an electromechanical brake system includes activating an electric motor, rotating a gear element with the electric motor, applying a clamping force to a brake disc through rotation of the gear element, energizing an actuator to deploy an actuation element, and locking rotation of the gear element with the actuation element.

In addition to one or more of the features described herein include de-activating the electric motor.

In addition to one or more of the features described herein include re-activating the electric motor to further rotate the gear element without releasing the actuation element.

In addition to one or more of the features described herein include re-activating the electric motor, releasing the actuation element, and de-activating the electric motor.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a vehicle including an electromechanical brake system including a parking lock, in accordance with an aspect of an exemplary embodiment;

FIG. 2 depicts an electromechanical brake caliper including a parking lock, in accordance with an aspect of an exemplary embodiment;

FIG. 3 depicts a block diagram of a parking lock control system, in accordance with an aspect of an exemplary embodiment;

FIG. 4 is a schematic representation of a parking lock in a deployed configuration, in accordance with an aspect of an exemplary embodiment;

FIG. 5 is a schematic representation of a parking lock in a non-deployed configuration, in accordance with an aspect of an exemplary embodiment; and

FIG. 6 is a flowchart depicting a method of applying a parking lock for an electromechanical brake, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

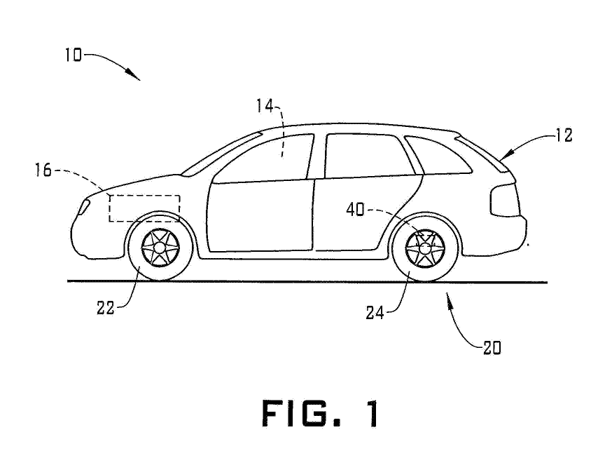

A vehicle, in accordance with an aspect of an exemplary embodiment, is indicated generally at 10 in FIG. 1. Vehicle 10 includes a body 12 that defines, at least in part, a passenger compartment 14. Vehicle 10 is also shown to include a prime mover 16 that may take the form of an internal combustion engine, an electric motor, a hybrid electric motor or the like. Prime mover 16 is mechanically connected to a plurality of wheels 20 through a transmission (not shown). Plurality of wheels 20 include front wheels 22 and rear wheels 24. Prime mover 16 may be drivingly connected to front wheels 22 and/or rear wheels 24 depending on design parameters. Vehicle 10 may be provided with an electromechanical brake system 40 shown in connection with rear wheels 24. It should be understood that front wheels 22 may also include corresponding electromechanical brake systems.

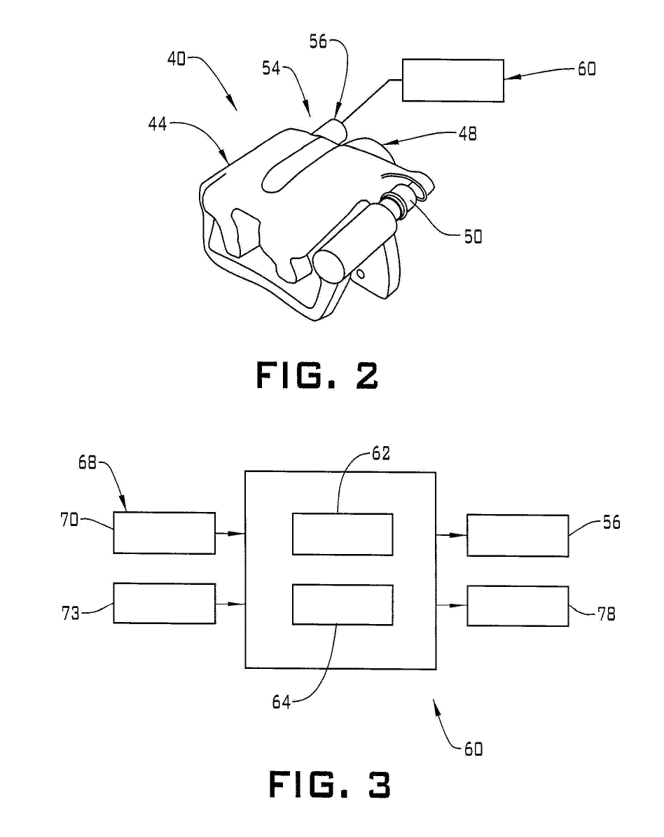

Referring to FIG. 2, and with continued reference to FIG. 1, electromechanical brake system 40 includes a caliper 44 that supports an electric motor 48. Electric motor 48 is selectively activated to shift caliper 44 on a pair of pins, one of which is indicated at 50, to deliver a clamping force to a brake disc (not shown) in order to slow movement of vehicle 10. Electric motor 48 is mechanically connected to a gear element 51, shown in FIG. 4. Gear element 51 may be directly, or indirectly driven by electric motor 48 to deliver the clamping force to the brake disc.

In accordance with an exemplary aspect, electromechanical brake system 40 includes a parking lock 54 mounted to caliper 44. Parking lock 54 includes an actuator 56 having an activation member 58 (FIG. 4) that selectively engages gear element 51. Parking lock 54 is operatively connected to a parking lock control system 60 that may selectively activate actuator 56 to prevent movement of vehicle 10 when the electric motor is de-energized.

Referring to FIG. 3, parking lock control system 60 may include a control module 62 which may receive a park lock command and an activation module 64 which may energize actuator 56. Parking lock control system 60 may be operatively connected to a brake activation mechanism 68 which could take the form of a brake switch 70 that could be a pedal, a button, a soft-switch or the like and a sensor 73 that determines an activation state of parking lock 54. Parking lock control system 60 may also be operatively connected to actuator 56 and an output element 78 that could provide one or more of a visual, an audible, and/or output signal indicating that parking lock 54 is deployed.

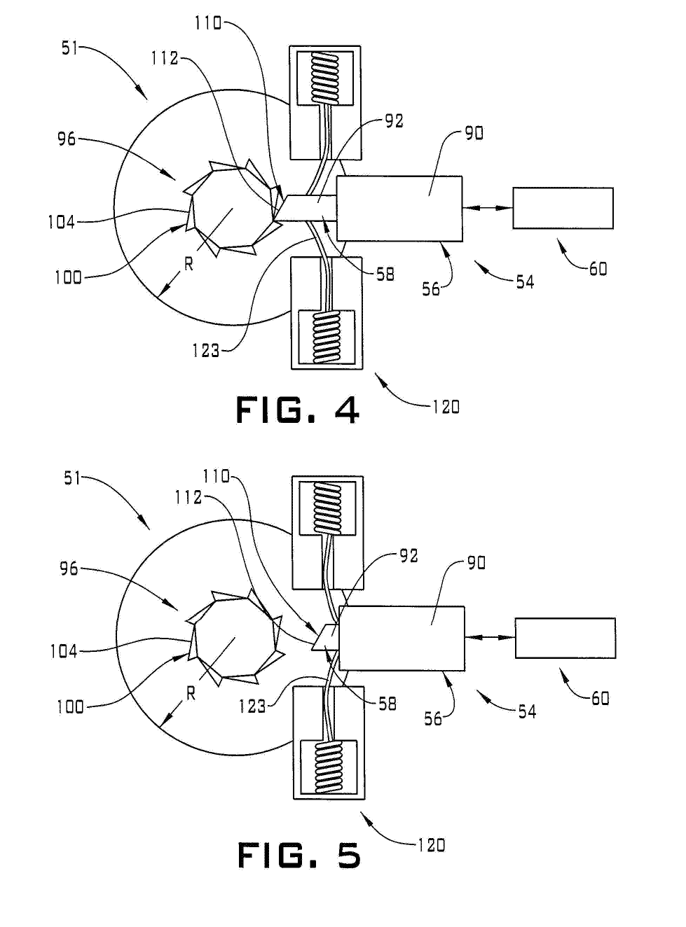

Referring to FIGS. 4 and 5 and with continued reference to FIGS. 1-3, actuator 56 may take the form of an electric solenoid 90 and activation member 58 may take the form of a solenoid plunger 92. Gear element 51 may include a parking gear 96 having a plurality of tooth elements, one of which is indicated at 100. Each tooth element 100 includes at least one surface 104 that is at a non-zero angle relative to a radius “R” of gear element 51. Solenoid plunger 92 includes a terminal end 110 having an angled surface 112. Angled surface 112 extends at an angle relative to a longitudinal axis (not separately labeled) and a transverse axis (also not separately labeled) of solenoid plunger 92.

Solenoid 90 includes a biasing element, shown schematically in FIGS. 4 and 5 at 120, that urges solenoid plunger 92 toward a deployed configuration (FIG. 4) and a non-deployed configuration (FIG. 5). Biasing element 120 may take the form of an over-center spring 123. Of course, it should be understood, that biasing element 120 may take on a variety of forms including those which urge solenoid plunger toward only one of the deployed configuration and the non-deployed configuration. In the deployed configuration, solenoid plunger 92 engages parking gear 96 to prevent rotation of gear element 51 to maintain electromechanical brake system 40 in a braked configuration.

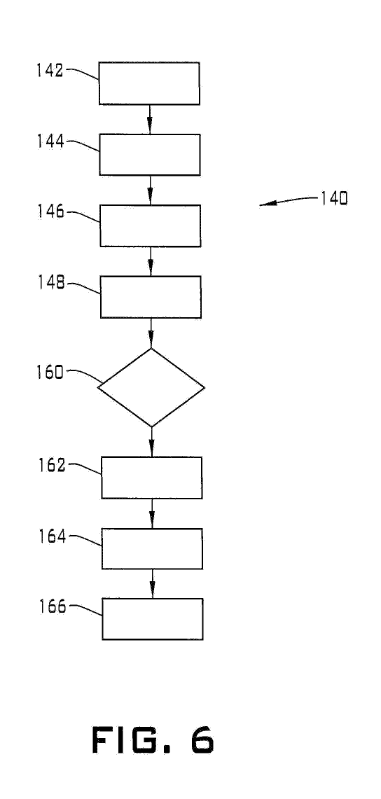

Reference will now follow to FIG. 6, with continued reference to FIGS. 1-5 in describing a method 140 of employing parking lock 54 of electromechanical brake system 40 in accordance with an exemplary aspect. In block 142, electric motor 48 is activated causing caliper 44 to apply a clamping force that prevents movement of vehicle 10. In block 144, a parking lock signal is received by parking lock control system 60, causing activation module 64 to energize actuator 56 so that activation member 58 engages parking gear 96. In block 146 electric motor 48 is de-energized, allowing caliper 44 to release such that the vehicle load may be carried by parking gear 96. A signal may be received by output element 78 indicating that parking lock 54 is active.

In block 148 parking lock control system 60 may signal activation module 64 to re-activate electromechanical brake system 40 and apply an additional clamping force through caliper 44. The re-activation of electromechanical brake system 40 may occur after a period of time of about 3-5 minutes from deactivation. The additional clamping force may cause rotation of gear element 51 such that activation member 58 ratchets over parking gear 96. In this manner, electromechanical brake system 40 may be adjusted to accommodate any dimensional changes of braking components that may occur as a result of cooling without releasing parking lock control system 60.

In block 160, a determination is made whether a parking lock release signal has been received. If the release signal is received, electric motor 48 is energized in block 162 causing caliper 44 to apply the clamping force and relieve pressure from parking gear 96. In block 164, activation member 58 is shifted to the de-activated configuration and in block 166 electric motor 48 is de-energized, releasing caliper 44 such that vehicle 10 may move.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electromechanical brake system comprising:
a caliper including a first caliper member and a second caliper member;
an electric motor mounted to the caliper;
a gear element mechanically connected to the electric motor;
an actuator supported by the caliper, the actuator including an actuation member; and
a controller operatively connected to the actuator, the controller being operable to selectively engage the actuation member with the gear element to positionally lock the first caliper member relative to the second caliper member.

2. The electromechanical brake system according to claim 1, wherein the actuator comprises a solenoid and the actuation member comprises a solenoid plunger.

3. The electromechanical brake system according to claim 1, wherein the gear element includes a parking gear including a plurality of tooth elements, each of the plurality of tooth elements including at least one surface that extends at a non-zero angle relative to a radius of the gear element.

4. The electromechanical brake system according to claim 3, wherein the actuation member includes a terminal end portion including an angled surface.

5. The electromechanical brake system according to claim 1, further comprising: a biasing element operatively connected to the actuation member, the biasing element biasing the actuation member in one of a deployed configuration and a non-deployed configuration.

6. The electromechanical brake system according to claim 5, wherein the biasing element biases the actuation member in each of the deployed configuration and the non-deployed configuration.

7. The electromechanical brake system according to claim 6, wherein the biasing element comprises an over-center spring.

8. A vehicle comprising:
a body;
a prime mover connected to the body;
a plurality of wheels connected to the prime mover; and
an electromechanical brake system operatively connected to at least one of the plurality of wheels, the electromechanical brake system comprising:
a caliper including a first caliper member and a second caliper member;
an electric motor mounted to the caliper;
a gear element mechanically connected to the electric motor;
an actuator supported by the caliper, the actuator including an actuation member; and
a controller operatively connected to the actuator, the controller being operable to selectively engage the actuation member with the gear element to positionally lock the first caliper member relative to the second caliper member.

9. The vehicle according to claim 8, wherein the actuator comprises a solenoid and the actuation member comprises a solenoid plunger.

10. The vehicle according to claim 8, wherein the gear element includes a parking gear including a plurality of tooth elements, each of the plurality of tooth elements including at least one surface that extends at non-zero angle relative to a radius of the gear element.

11. The vehicle according to claim 10, wherein the actuation member includes a terminal end portion including an angled surface.

12. The vehicle according to claim 8, further comprising: a biasing element operatively connected to the actuation member, the biasing element biasing the actuation member in one of a deployed configuration and a non-deployed configuration.

13. The vehicle according to claim 12, wherein the biasing element biases the actuation member in each of the deployed configuration and the non-deployed configuration.

14. The vehicle according to claim 13, wherein the biasing element comprises an over-center spring.

15. A method of applying a parking brake for an electromechanical brake system comprising:
activating an electric motor;
rotating a gear element with the electric motor;
applying a clamping force to a brake disc through rotation of the gear element;
energizing an actuator to deploy an actuation element; and
locking rotation of the gear element with the actuation element.

16. The method of claim 15, further comprising: de-activating the electric motor.

17. The method of claim 16, further comprising: re-activating the electric motor to further rotate the gear element without releasing the actuation element.

18. The method of claim 16, further comprising:
re-activating the electric motor;
releasing the actuation element; and
de-activating the electric motor.
